(19) United States
(12) Patent Application Publication
(10) Pub. No.: US 2012/0026209 A1
(43) Pub. Date: Feb. 2, 2012

(54) COLOR DISPLAY DEVICE

(75) Inventors: YI-CHING WANG, Hsinchu (TW); Tung-Liang Lin, Hsinchu (TW); Lee-Tyng Chen, Hsinchu (TW)

(73) Assignee: E Ink Holdings Inc., Hsinchu City (TW)

(21) Appl. No.: 13/112,404

(22) Filed: May 20, 2011

(30) Foreign Application Priority Data
Jul. 28, 2010 (TW) 099124939

(51) Int. Cl. G09G 3/34; G09G 5/02

(52) U.S. Cl. 345/690; 345/107

(57) ABSTRACT

A color display device including a lower substrate, a driving array, a display layer, a color filter substrate and a transparent substrate is provided. The driving array is disposed on the lower substrate. The display layer is disposed on the driving array and includes a first region and a second region. The color filter substrate is disposed on the display layer and is located in the first region. The transparent substrate is disposed on the display layer and is located in the second region. The color display device has a high light reflectivity, thereby improving the display quality of the color display device.

### FIELD OF THE INVENTION

The present invention relates to a display device, and more particularly to a color display device.

### BACKGROUND OF THE INVENTION

A conventional electrophoretic display device generally includes a black and white electrophoretic display layer and is a black and white display device. In order to make the electrophoretic display device stand more competitive power, a color filter is generally used to achieve a colorful effect of the conventional electrophoretic display device. Thus, the electrophoretic display device can satisfy the colorful trend of the current display devices.

Currently, a traditional color filter applied in a color electrophoretic display device generally includes a substrate and a number of color filter patterns disposed on the substrate. The traditional color filter is adhered to the black and white electrophoretic display layer of the electrophoretic display device. The color filter patterns (e.g., red filter patterns, green filter patterns and blue filter patterns) are cooperated with the black electrophoretic particles and the white electrophoretic particles of the black and white electrophoretic display layer to achieve the colorful effect of the color electrophoretic display device. However, the color filter patterns of the traditional color filter are generally made of color photoresist materials. The color filter patterns will absorb light to cause light loss so that the color filter has a poor light transmission. When the traditional color filter is adhered to the black and white electrophoretic display layer of a reflective electrophoretic display device, the black and white electrophoretic display layer is entirely covered by the color filter. As a result, the total light reflectivity of the reflective electrophoretic display device will be decreased due to the color filter with poor light transmission, thereby affecting the display quality of the electrophoretic display device.

### SUMMARY OF THE INVENTION

The present invention provides a color display device with high light reflectivity. Thus, the display brightness of the color display device can be increased, thereby improve the quality of the color display device.

The present invention provides a color display device including a lower substrate, a driving array, a display layer, a color filter substrate and a transparent substrate. The driving array is disposed on the lower substrate. The display layer is disposed on the driving array and includes a first region and a second region. The color filter substrate is disposed on the display layer and is located in the first region. The transparent substrate is disposed on the display layer and is located in the second region.

In one embodiment provided by the present invention, the color filter substrate includes a transparent base plate and a color filter layer. The color filter layer includes a plurality of color photoresist patterns and is disposed between the transparent base plate and the display layer.

In one embodiment provided by the present invention, the transparent base plate is either a transmissive glass or an optical plastic film.

In one embodiment provided by the present invention, a thickness of the transparent substrate is equal to a thickness of the color filter layer and a thickness of the transparent base plate, and the transparent base plate is integrated with the transparent substrate.

In one embodiment provided by the present invention, the transparent substrate is either a transmissive glass or an optical plastic film.

In one embodiment provided by the present invention, the display layer is an electrophoretic display layer.

In one embodiment provided by the present invention, an area ratio of the first region and the second region is in a range from 20% to 80%.

The present invention also provides a color display device including a lower substrate, a driving array, a first front plane laminate (FPL), a second front plane laminate and a color filter substrate. The driving array is disposed on the lower substrate and includes a third region and a fourth region. The first front plane laminate is disposed on the driving array and is located in the third region. The second front plane laminate is disposed on the driving array and is located in the fourth region. The color filter substrate is disposed on the first front plane laminate.

In one embodiment provided by the present invention, the color display device further includes a transparent substrate disposed on the second front plane laminate.

In one embodiment provided by the present invention, an area ratio of the third region and the fourth region is in a range from 20% to 80%.

In the color display device of the present invention, the color filter substrate only covers a portion of a display region to achieve the colorful effect. A portion of the display region which is not covered by the color filter substrate can avoid light brightness loss caused by the poor color filter substrate with light transmission. Thus, the light reflectivity and the light brightness of the color display device can be increased, thereby improving the quality of the color display device.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a schematic, top view of a color display device in accordance with a first embodiment of the present invention.

FIG. 2 illustrates a schematic, cross-sectional view of the color display device along the line II-II in accordance with the first embodiment of the present invention.

FIG. 3 illustrates a schematic, cross-sectional view of a color display device in accordance with a second embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

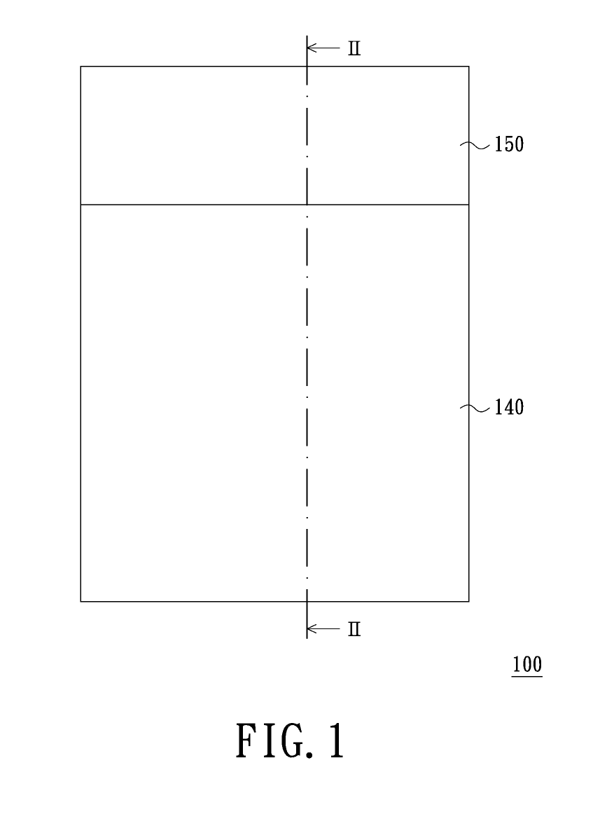

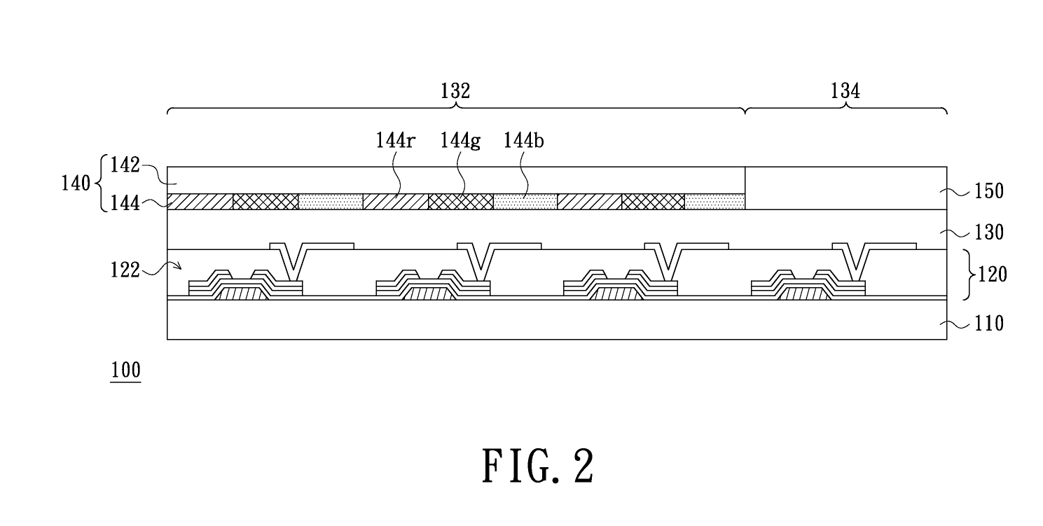

FIG. 1 illustrates a schematic, top view of a color display device in accordance with a first embodiment of the present invention. FIG. 2 illustrates a schematic, cross-sectional view of the color display device along the line II-II in accordance with the first embodiment of the present invention. Referring to FIG. 1 and FIG. 2, in the present embodiment, the color display device 100 includes a lower substrate 110, a driving array 120, a display layer 130, a color filter substrate 140 and a transparent substrate 150. The driving array 120 is disposed on the lower substrate 110. The display layer 130 is disposed on the driving array 120 The color filter substrate 140 and the transparent substrate 150 are disposed on the display layer 130.

The lower substrate 110 can be, but not limited to, a rigid substrate, for example, a glass substrate or a metal substrate.

The driving array 120 is disposed on the lower substrate 110 and includes a plurality of thin film transistors 122 arranged in an array. The thin film transistors 122 can be, but not limited to, amorphous silicon thin film transistors (a-Si TFT), poly-silicon thin film transistors (poly-Si TFT), low temperature poly-silicon thin film transistors (LTPS-TFT), organic thin film transistors (OTFT) or oxide thin film transistors (oxide-TFT).

The display layer 130 is, for example, a black and white electrophoretic display layer. The display layer 130 is disposed on the driving array 120. The display layer 130 can be a microencapsulated electrophoretic display layer or microcup electrophoretic display layer, and is not described here. In the present embodiment, the display layer 130 includes a first region 132 and a second region 134 adjacent to the first region 132. The first region 132 and the second region 134 constitute a display region of the color display device 100. An area ratio of the first region 132 and the second region 134 is in a range from 20% to 80%. It is noted that the display layer 130 can be other black and white display layer, for example, a liquid crystal display layer.

The color filter substrate 140 is disposed on the display layer 130 and is located in the first region 132 of the display layer 130. In the present embodiment, the color filter substrate 140 includes a transparent base plate 142 and a color filter layer 144. The transparent base plate 142 is made of a material with high light transmission. The transparent base plate 142 can be, but not limited to, a transmissive glass or an optical plastic film. The optical plastic film can be, for example, a macromolecule film selected from a group consisting of polyimide (PI), polyethylene terephthalate (PET), polyethersulfone (PES), polyethylene naphthalene (PEN), polycarbonate (PC). The color filter layer 144 is disposed between the transparent base plate 142 and the display layer 130 in the first region 132. The color filter layer 140 includes a plurality of color photoresist patterns. The color photoresist patterns includes, for example, a plurality of red photoresist patterns 144r, a plurality of green photoresist patterns 144g and a plurality of blue photoresist patterns 144b.

The transparent substrate 150 is disposed on the display layer 130 and is located in the second region 134 of the display layer 130. The transparent substrate 150 is made of a material with high light transmission. The transparent substrate 150 can be, but not limited to, a transmissive glass or an optical plastic film. The optical plastic film can be, for example, a macromolecule film selected from a group consisting of polyimide (PI), polyethylene terephthalate (PET), polyethersulfone (PES), polyethylene naphthalene (PEN), polycarbonate (PC). It is noted that, the transparent substrate 150 can be integrated with the transparent base plate 142. In other words, the transparent substrate 150 and the transparent base plate 142 are connected together as a whole. Preferably, a thickness of the transparent substrate 150 is equal to a thickness of the color filter layer 144 and a thickness of the transparent base plate 142. Thus, the color filter substrate 140 and the transparent substrate 150 can adhere to the display layer 130 flushly.

In the color display device 100, the color filter substrate 140 only covers the first region 132. The second region 134 is not covered by the color filter substrate 140. Thus, the first region 132 of the display layer 130 can achieve the colorful effect by the color filter substrate 140. The second region 134 of the display layer 130 without the color filter substrate 140 still displays a black and whit image. Meanwhile, the light through the second region 134 can penetrate the transparent substrate 150 to arrive at the display layer 130. Thus, the light loss caused by the color filter substrate 140 can be avoided. As a result, the light reflectivity and the light brightness of the color display device 100 can be increased, thereby increasing color light brightness of the display layer 130 in the first region 132, and further improving the quality of the color display device 100.

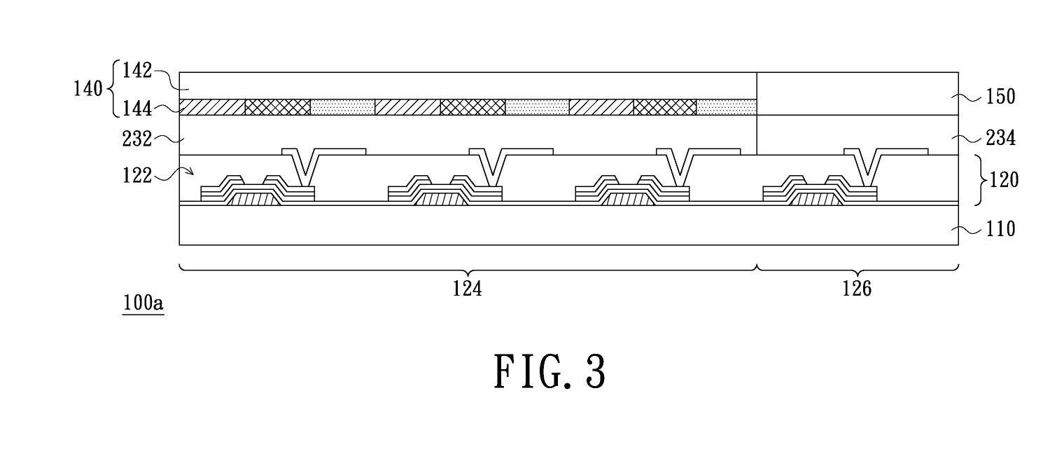

FIG. 3 illustrates a schematic, cross-sectional view of a color display device in accordance with a second embodiment of the present invention. Referring to FIG. 3, the color display device 100a in the present embodiment is similar to the color display device 100 in the first embodiment except the display layer. In detail, in the present embodiment, the color display device 100a includes a lower substrate 110, a driving array 120, a first front plane laminate (FPL) 232, a second front plane laminate 234 and a color filter substrate 140. The driving array 120 is disposed on the lower substrate 110. The first front plane laminate 232 and the second front plane laminate 234 are disposed on the driving array 120. The color filter substrate 140 is disposed on the first front plane laminate 232.

In the present embodiment, the driving array 120 includes a third region 124 and a fourth region 126. In the present embodiment, the third region 124 is adjacent to the fourth region 126. The t third region 124 is adjacent to the fourth region 126 constitute a display region of the color display device 100a. An area ratio of the third region 124 is adjacent to the fourth region 126 is in a range from 20% to 80%.

Each of the first front plane laminate 232 and the second front plane laminate 234 includes an electrophoretic layer (not shown) and a transparent electrode layer (not shown) disposed on the electrophoretic layer. The front plane laminate technology is familiar to the one skilled in the art and is not described here. In the present embodiment, the electrophoretic layer can be, for example, a black and whit electrophoretic layer. The first front plane laminate 232 is disposed on the driving array 120 and is located in the third region 124 of the driving array 120. The second front plane laminate 234 is disposed on the driving array 120 and is located in the fourth region 126 of the driving array 120.

In the color display device 100a, the color filter substrate 140 only covers the first front plane laminate 232. The color filter layer 144 is disposed between the transparent base plate 142 first front plane laminate 232. The second front plane laminate 234 is not covered by the color filter substrate 140. Thus, the first front plane laminate 232 can achieve the colorful effect by the color filter substrate 140. The second front plane laminate 234 without the color filter substrate 140 still displays a black and whit image. Meanwhile, the light will not be through the color filter substrate 140 to arrive at the second front plane laminate 234. Thus, the light loss caused by the color filter substrate 140 can be avoided. As a result, the light reflectivity and the light brightness of the color display device 100a can be increased, thereby increasing color light brightness of the first front plane laminate 232, and further improving the quality of the color display device 100a.

Additionally, in the present embodiment, the color display device 100a further includes a transparent substrate 150 disposed on the second front plane laminate 234 to protect the second front plane laminate 234. The light through can directly penetrate the transparent substrate 150 to arrive at the second front plane laminate 234. As a result, the light reflectivity and the light brightness of the color display device 100a can be increased, thereby improving the quality of the color display device 100a.

It is noted that, a number of the first front plane laminate 232 and the second front plane laminate 234 corresponds to a number of the third region 124 and the fourth region 126 of the driving array 120. In other words, a number of the front plane laminates disposed on the driving array 120 is not limited by the first front plane laminate 232 and the second front plane laminate 234 in the present embodiment, and the color display device 100a can includes more than two front plane laminates on the driving array 120.

In summary, in the color display device of the present invention, the color filter substrate only covers a portion of a display region to achieve the colorful effect. A portion of the display region which is not covered by the color filter substrate can avoid light brightness loss caused by the color filter substrate with poor light transmission. Thus, the light reflectivity and the light brightness of the color display device can be increased, thereby improving the quality of the color display device.

While the invention has been descry bed in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A color display device, comprising:
a lower substrate;
a driving array disposed on the lower substrate;
a display layer disposed on the driving array, the displaying layer comprising a first region and a second region;
a color filter substrate disposed on the display layer and located in the first region; and
a transparent substrate disposed on the display layer and located in the second region.

2. The color display device as claimed in claim 1, wherein the color filter substrate comprises:
a transparent base plate; and
a color filter layer comprising a plurality of color photoresist patterns, the color filter layer being disposed between the transparent base plate and the display layer.

3. The color display device as claimed in claim 2, wherein the transparent base plate is either a transmissive glass or an optical plastic film.

4. The color display device as claimed in claim 2, wherein a thickness of the transparent substrate is equal to a thickness of the color filter layer and a thickness of the transparent base plate, and the transparent base plate is integrated with the transparent substrate.

5. The color display device as claimed in claim 1, wherein the transparent substrate is either a transmissive glass or an optical plastic film.

6. The color display device as claimed in claim 1, wherein the display layer is an electrophoretic display layer.

7. The color display device as claimed in claim 1, wherein an area ratio of the first region and the second region is in a range from 20% to 80%.

8. A color display device, comprising:
a lower substrate;
a driving array disposed on the lower substrate, the driving array comprising a third region and a fourth region;
a first front plane laminate disposed on the driving array and located in the third region;
a second front plane laminate disposed on the driving array and located in the fourth region; and
a color filter substrate disposed on the first front plane laminate.

9. The color display device as claimed in claim 8, further comprising a transparent substrate disposed on the second front plane laminate.

10. The color display device as claimed in claim 8, wherein an area ratio of the third region and the fourth region is in a range from 20% to 80%.
